(19) United States
(12) Patent Application Publication
(10) Pub. No.: US 2006/0053634 A1
(43) Pub. Date: Mar. 16, 2006

(54) Scissors having a middle finger guide

(76) Inventor: Randall Scott Ferman, Millburn, NJ (US)

Correspondence Address: LERNER, DAVID, LITTENBERG,;KRUMHOLZ & MENTLIK, 600 SOUTH AVENUE WEST, WESTFIELD, NJ, 07090, US

(21) Appl. No.: 11/269,011

(22) Filed: Nov. 8, 2005

Related U.S. Application Data
(62) Division of application No. 10/818,889, filed on Apr. 6, 2004.
Application No. 10/818,889 is a continuation-in-part of application No. 29/195,696, filed on Dec. 16, 2003, now Pat. No. D502070.

(51) Int. Cl. B26B 13/00

(52) U.S. Cl. 30/232

(57) ABSTRACT

A pair of scissors includes a pair of spaced apart cutting blades manipulatable by the operator's fingers receiving within a pair of finger receiving openings. One of the finger receiving openings is formed from an arcuate shaped member from which there extends a projection forming a finger stop. The projection restricts the user's middle finger from sliding over the arcuate shaped member during use of the scissors.

### CROSS REFERENCES TO RELATED APPLICATIONS

This application is a divisional application of application Ser. No. 10/818,889, filed Apr. 6, 2004, entitled Scissors Having a Middle Finger Guide, which is a continuation in part of application Ser. No. 29/195,696, filed Dec. 16, 2003, entitled Scissors Having a Middle Finger Guide, the disclosures of which are hereby incorporated herein by reference.

### BACKGROUND OF THE INVENTION

Scissors are universally used in the cutting of hair in beauty salons and in barbershops. Although scissors are manufactured in various designs and constructions, they almost always incorporate two pivotably connected blades each having coacting cutting regions on one side of the pivot point and handle portions provided on the other side of the pivot point with finger and thumb supports. Manipulation by the operator of the scissors by relative movement of the operator's fingers and thumb causes corresponding pivotable movement of the cutting blades whereby the cutting regions cooperate to cut hair positioned therebetween.

The operation and control of the scissors during the cutting process requires use of various muscles of the person's hand, wrist, and fingers. In order to prevent fatigue and possible injury to the operator's extremities, the position of the operator's fingers in holding the scissors is a significant concern. Conventional scissors are provided with various finger and thumb openings for positioning these extremities at various locations along the scissor. See, for example, U.S. Pat. Nos. 3,825,020; 2,669,993; 2,677,179; and 2,370,026.

Notwithstanding the foregoing, there remains the need for improvements in the design and construction of scissors that allow greater flexibility and control in manipulation of the cutting blades, while lessening fatigue and possible injury to the operator's hand, wrist, and/or fingers during prolonged use.

### SUMMARY OF THE INVENTION

In accordance with one embodiment of the present invention, there is described a scissors comprising a first blade having a cutting region and a first handle, a second blade having a cutting region and a second handle, the first and second blades pivotally coupled together with their cutting regions in cooperation with each other, the first handle including a handle extension having an arcuate shaped member providing a first finger receiving opening, the arcuate shaped member having a first sloped segment directed towards the cutting region of the first blade and a second sloped segment directed away from the cutting region of the first blade, a first projection extending outwardly from the first sloped segment and a second projection extending outwardly from the first handle spaced from the first projection, the first and second projections providing therebetween a third finger opening adapted to receive a person's finger.

In accordance with another embodiment of the present invention there is described a scissors comprising a first blade having a cutting region and a first handle, a second blade having a cutting region and a second handle, the first and second blades pivotally coupled together with their cutting regions in cooperation with each other, the first handle including a first handle extension providing a first finger receiving opening and the second handle including a second handle extension providing a second finger receiving opening, the first handle extension including an arcuate shaped member having a crest, a first projection extending outwardly from the arcuate shaped member and a second projection extending outwardly from the first handle spaced from the first projection, the first projection arranged between the crest of the arcuate shaped member and the second projection thereby providing a third finger receiving opening therebetween adapted to receive a person's finger.

In accordance with another embodiment of the present invention there is described a scissors comprising a first blade having a cutting region and a first handle, a second blade having a cutting region and a second handle, the first and second blades pivotally coupled together with their cutting regions in cooperation with each other, the first handle including a first handle extension providing a first finger receiving opening and the second handle including a second handle extension providing a second finger receiving opening, the first handle extension including a first projection extending outwardly therefrom and the first handle including a second projection extending outwardly therefrom, the first and second projections spaced apart to provide therebetween a second finger receiving opening adapted to receive the middle finger of a person while preventing sliding movement of the person's middle finger over the first handle extension.

In accordance with another embodiment of the present invention there is described a scissors comprising a first blade having a cutting region and a first handle, a second blade having a cutting region and a second handle, the first and second blades pivotally coupled together with their cutting regions in cooperation with each other, the first handle including a first handle extension providing a first finger receiving opening, the first handle extension including an arcuate shaped member having a first segment directed towards the cutting region of the first blade and a second segment directed away from the cutting region of the first blade, a projection extending outwardly from the first segment providing a stop to prevent sliding movement of a person's finger onto the second segment of the first handle extension.

### BRIEF DESCRIPTION OF THE DRAWINGS

The above description, as well as further objects, features and advantages of the present invention will be more fully understood with reference to the following detailed description of Scissors Having a Middle Finger Guide, when taken in conjunction with the accompanying drawings, wherein:

FIG. 1 is a top plan view of a pair of scissors incorporating spaced-apart projections providing middle finger support in accordance with one embodiment of the present invention;

FIG. 2 is a top plane view of a plurality of ring inserts illustrated in groups of predetermined outside and inside diameters in accordance with one embodiment of the present invention;

FIG. 3 is a front elevational view of a ring insert constructed in accordance with one embodiment of the present invention;

FIG. 4 is a top plane view of a pair of scissors having a pair of ring inserts inserted therein in accordance with one embodiment of the present invention;

FIG. 5 is a top plane view of a sizing template for selecting a ring insert constructed in accordance with one embodiment of the present invention; and

FIG. 6 is a top plane view of a sizing template for selecting a ring insert constructed in accordance with another embodiment of the present invention.

### DETAILED DESCRIPTION OF PREFERRED EMBODIMENTS

In describing the preferred embodiments of the invention illustrated in the drawings, specific terminology will be used for the sake of clarity. However, the invention is not intended to be limited to the specific terms so selected, and it is to be understood that each specific term includes all technical equivalents that operate in a similar manner to accomplish a similar purpose.

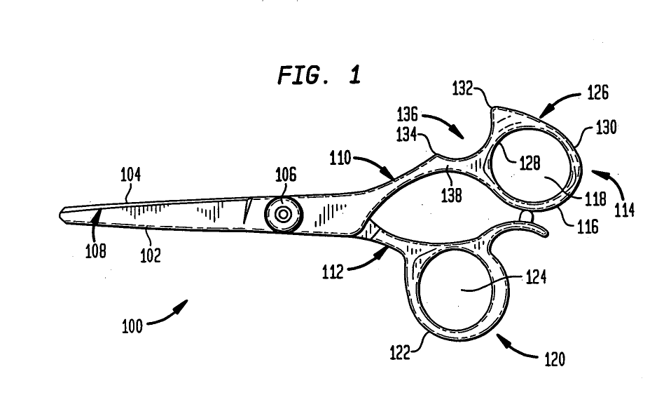

Referring now to the drawings, wherein like reference numerals represent like elements, there is shown in FIG. 1 a pair of scissors generally designated by reference numeral 100. The scissors 100 includes a pair of elongated blades 102, 104, which are pivotably connected together at pivot point 106 by any conventional assembly as is well known in the scissor's art. Each of the blades 102, 104 includes a cutting region 108 disposed forward of the pivot point 106 and a respective handle 110, 112. Handle 110 is further provided with a handle extension 114 formed by an arcuate shaped member 116 that defines a finger receiving opening 118. In a similar manner, the handle 112 is provided with a handle extension 120 formed by an arcuate shape member 122 defining a finger receiving opening 124.

The arcuate shape member 116 of handle extension 114 includes a crest 126 arranged generally midway along the upper portion of the arcuate shape member as shown in FIG. 1. The arcuate shape member 116 is further defined by a sloped segment 128 generally directed toward the cutting region 108 and a sloped segment 130 generally directed away from the cutting region. As illustrated, the crest 126 is generally located at the apex of the arcuate shaped member 116 centered between the sloped segments 128, 130.

The finger receiving opening 118 is generally a circular shaped opening, or a variation thereof, such as an oval shaped opening and the like. The finger receiving opening 118 is therefore defined by the arcuate shaped member 116 that defines the slope segments 128, 130 extending on either side of the crest 126.

A projection 132 is formed extending outwardly from the sloped segment 128 along the arcuate shaped member 116. Another projection 134 is formed extending outwardly from the handle 110 arranged spaced from projection 132 to provide a finger receiving opening 136 therebetween. As shown, the projection 132 is arranged generally adjacent the crest 126 of the arcuate shaped member 116. The resulting finger receiving opening 136 is partially bordered by the arcuate side surfaces of the projections 132, 134 and an intervening arcuate shaped portion 138 of the handle 110.

In accordance with one embodiment of the present invention, the projections 132, 134 are triangular in shape, projection 132 being larger than projection 134. The projections 132, 134 can be integrally formed during manufacture of the handle 110 using conventional manufacturing techniques. It is also contemplated that the projections 132, 134 may have other shapes, such as square, cylindrical, C-shaped, hook-shaped, polygonal, or any other shape that is suitable for defining a finger receiving opening 136 therebetween. Although the projections 132, 134 are preferably integrally formed with the handle 110, they may be detachable or separately secured to the handle. For example, the projections 132, 134 may be detachable by including a threaded portion adapted to receive a threaded portion on the handle 110, for example, threaded stud and threaded opening combination. In addition, the projections 132, 134 may be provided in separate pieces that are welded or otherwise attached to the handle 110. The projections 132, 134 may also be formed of polymer materials that can be snapped fit about portions of the handle 110 and the arcuate shaped member 114.

In use of the scissors, one's thumb is inserted into the finger receiving opening 124, one's ring finger is inserted into finger receiving opening 118, and one's middle finger is received within the finger receiving opening 136. In certain circumstances, the operator may place their middle finger into the finger receiving opening 118 and their index finger into the finger receiving opening 136. In either event, the finger receiving opening 136 is adapted to restrict sliding of the person's finger up the slope segment 128, passed the crest 126, and onto the slope segment 130. The projection 132 effectively acts as a stop in the rearward direction to preclude displacement of one's finger from the proper cutting position within the finger receiving opening 136. In a similar manner, projection 134 acts as a stop, restricting sliding of one's finger forwardly along the handle 110.

The present invention has thus far been described with respect to the preferred embodiment. In this regard, the preferred embodiment includes a pair of spaced apart projections 132, 134. As noted, projection 132 functions as a stop to restrict the person's finger from sliding up and over the arcuate shaped member 116 defining the handle extension 114. It is contemplated that only a single projection 132 is required in accordance with the broad aspects of the present invention. Although preferred, it is not a requirement that projection 134 be incorporated into the construction of the handle 110.

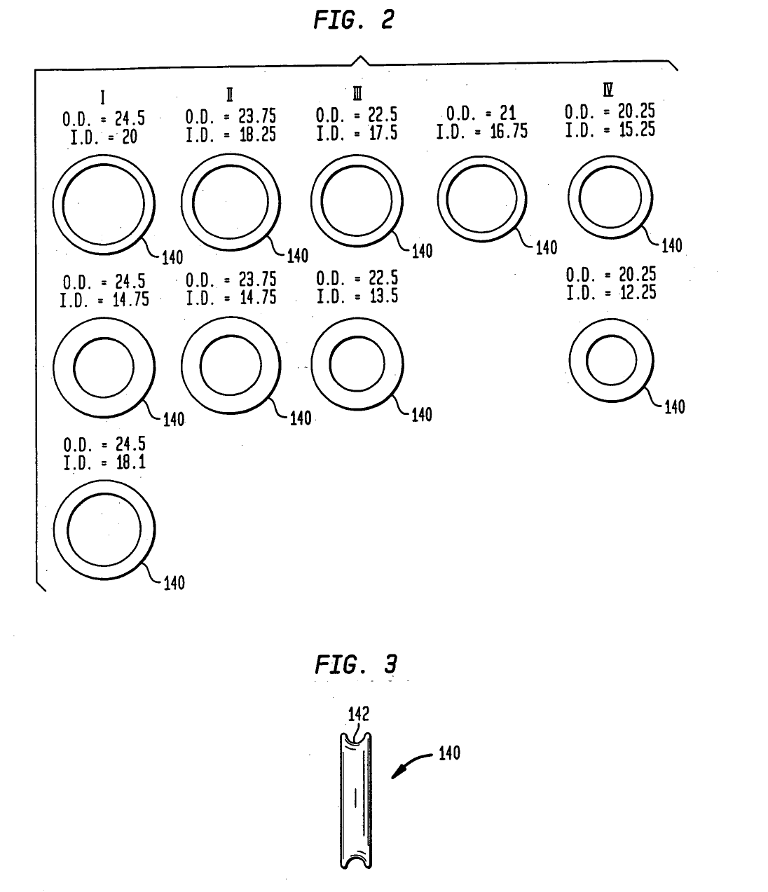

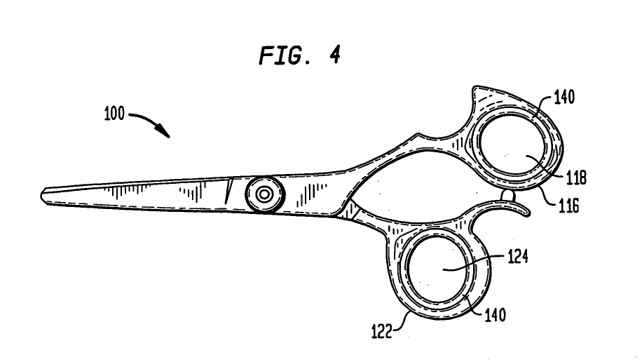

In order to adapt a pair of scissors to the finger size of a particular user, the present invention provides a plurality of ring inserts 140 as shown in FIGS. 2 and 3. The ring inserts are constructed in the nature of a circular shaped ring from any one of a number of known polymer materials possessing resilient and/or flexible properties. The ring inserts 140 are shaped to conform generally to the shape of the finger receiving openings 118, 124, for example, circular, oval, or the like. However, it is contemplated that due to the flexible and/or resilient nature of the ring inserts, circular shaped ring inserts can be adapted for use in oval shaped finger receiving openings 118, 124. As best shown in FIG. 3, each of the ring inserts 140 has an outer edge circumscribed by a generally continuous groove 142 or other such recess, the purpose of which will be described hereinafter.

In order to adapt a pair of scissors to the finger size of the operator, the ring inserts 140 are provided in various combinations of outside diameter and inside diameter. In this regard, the ring inserts 140 are provided in pairs or groups of at least two ring inserts to be received within a finger receiving opening 118, 124 of a designated size, while accommodating for different user finger sizes. In accordance with the preferred embodiments of the present invention, the ring inserts 140 are provided in a plurality of groups, each group including at least a pair of ring inserts having the same outside diameter, but different inside diameters. The ring inserts 140 may be packaged in a kit containing a single group of ring inserts, or a plurality of groups of ring inserts, each group including at least a pair of inserts of the same outside diameter, but different inside diameters. It is further contemplated that the groups may include more than a pair of ring inserts 140 to accommodate a greater range of operator finger sizes.

Referring again to FIG. 2, there is illustrated by way of one embodiment a kit including three ring inserts 140 designated as group I. Each of the ring inserts 140 have an outside diameter of about 24.5 millimeters, and an inside diameter of about 20 millimeters, 18.1 millimeters, and 14.75 millimeters, respectively. A kit of ring inserts 140 may also include those shown in group II including a pair of ring inserts having an outside diameter of about 23.75 millimeters and an inside diameter of about 18.25 millimeters and 14.75 millimeters, respectively. A kit of ring inserts can further include the pair of ring inserts 140 shown in group III having an outside diameter of about 22.5 millimeters and an inside diameter of about 17.5 millimeters and 13.5 millimeters, respectively. Still further, a ring insert kit may include the pair of ring inserts shown in group IV having an outside diameter of about 20.25 millimeters and an inside diameter of about 15.25 millimeters and 12.25 millimeters, respectively.

Other outside and inside diameters are contemplated within the present invention although not specifically identified. The above described ring inserts have their inside diameter ranging from about 4.25 millimeters to about 9.75 millimeters smaller than their outside diameter. The size difference in the described ring inserts is in the range of about 18% to about 40% smaller inside diameter than the outside diameter.

It is to be understood that any number of ring inserts 140 may be included in any one of the aforementioned groups I-IV. In addition, a kit of ring inserts 140 may include the insert rings of any single one group or the insert rings of a plurality of groups I-IV, packaged together, commingled or separately maintained in identified groups. Thus, the term “group” is not intended to mean that the plurality of ring inserts 140 are required to be identifiable or provided in separate groups thereof. As such, the plurality of ring inserts 140 from more than one group can be commingled with each other for selection by the user.

In a preferred embodiment, each of the ring inserts 140 shown in groups I-IV will be included in a single kit. In addition, odd sized ring inserts may be included in any one of the aforementioned groups and packaged in one of the aforementioned ring insert kits. One such ring insert 146 is shown in FIG. 2 having an outside diameter of about 21 millimeters and an inside diameter of about 16.75 millimeters. It should be appreciated that a kit of ring inserts includes at least one pair of ring inserts 140 having the same outside diameter, but a different inside diameter. The ring insert kit may have any number of groups including any number or ring inserts 140 of various sizes predetermined to accommodate the various scissor's constructions and finger sizes of the operators.

Turning to FIG. 4, the user selects an appropriate ring insert 140 for each of the finger receiving openings 118, 124 if required. Once selected, the ring insert 140 is pressed into the finger receiving opening 118, 124 whereby the arcuate shaped member 116, 122 is received within the groove 142 extending around the periphery of the ring insert. Depending upon the resiliency and flexibility of the ring insert 140, the ring insert may be force fit into the finger receiving openings 118, 124, or twisted into a reduced diameter, and allowed to assume its pretwisted shape to snuggly engage the arcuate shaped member 116, 122 within the ring insert's groove 142. In this manner, ring inserts 140 may be inserted and removed from the scissors 100 as may be required of the user. The ring inserts 140, by proper selection, provide an opening of proper size to accommodate the size of the user's fingers.

The ring inserts 140 may be sized manually by the user placing his finger and thumb within one of the ring inserts to determine its fit. Once the appropriate ring insert 140 is selected, the ring insert may be fit into one of the ring receiving openings 118, 124 of the scissors 100. The procedure for selecting a ring insert 140 in this manner, is a trial and error procedure that may be repeated as may be required to obtain the proper scissors fit. This is facilitated by the ring inserts 140 being removable once inserted into the scissors 100.

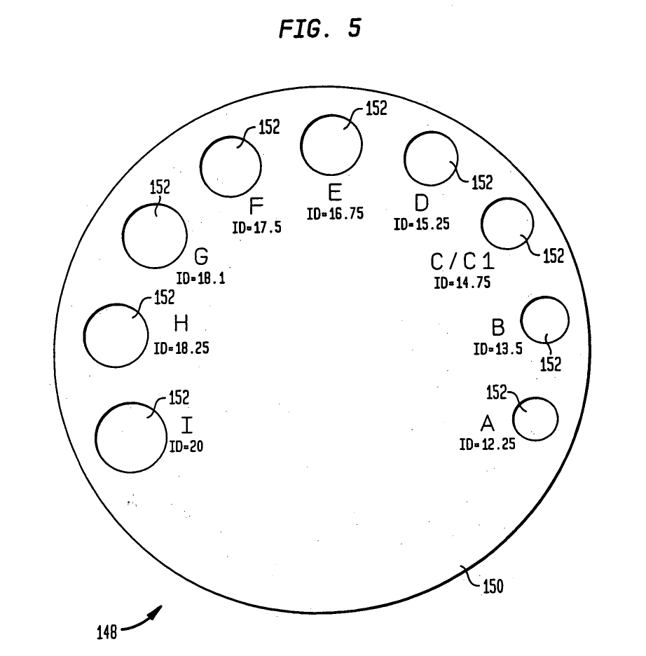

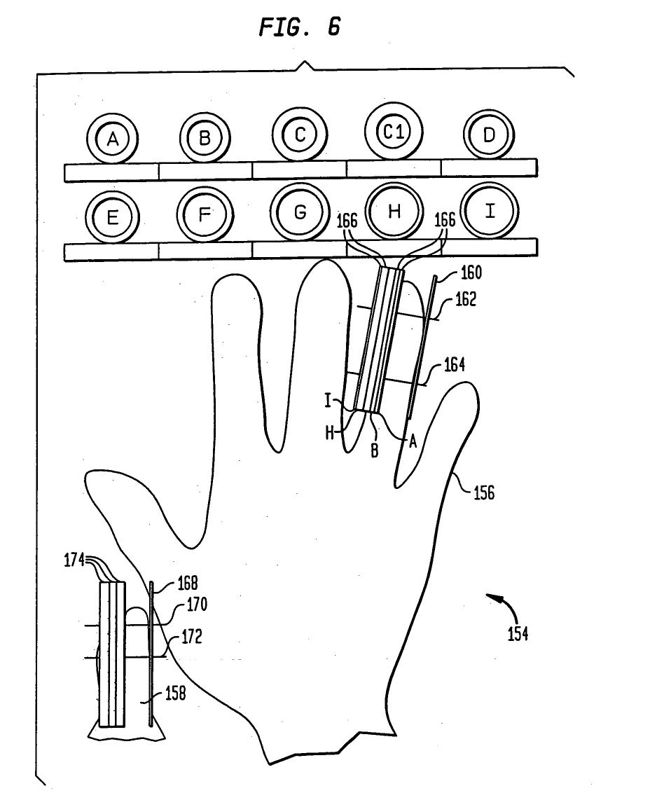

The ring inserts 140 may also be selected with the aide of a template 148 as shown in FIG. 5. The template 148 is constructed in the nature of a generally flat plate 150 including a plurality of circular holes 152. The holes 152 may be arranged on the template 148 in any arrangement and any location as desired. In addition, the template 148 although shown as circular, may have any shape and predetermined thickness. It should therefore be appreciated that the plate 150 provides a support for the hole 152.

In accordance with the preferred embodiment, the holes 152 are sized to have a diameter corresponding to the inside diameter of the ring inserts 140, 146 as shown in FIG. 2. For ease of use, the holes 152 are arranged about the periphery of the plate 150 in order of increasing or decreasing inside diameter. However, the holes 152 may be arranged in the plate 150 at any location or in a random pattern or array.

In selecting a ring insert 140, the user inserts his ring or other finger into one of the holes 152 to determine its fit. In this regard, the inside diameter of the hole 152 should fit snuggly about the person's ring finger between the first and second knuckle from the tip of the person's finger. This process of measurement is repeated using the person's thumb to determine a snug fit between the mid-point of the thumbnail and the bottom of the thumb cuticle. The corresponding inside diameter of the selected holes 152 are noted so as to select a corresponding ring insert 140.

By way of example, upon measuring a ring finger size of 17.9 millimeters, the user would select the corresponding ring insert 140 from group I having the same inside diameter and an outside diameter of 24.5 millimeters. The ring insert 140 is placed into the finger receiving opening 118 to size the opening for the person's ring finger. By way of another example, upon identifying a finger size of 14.75 millimeters, the user can select one of the ring inserts 140 from either group I or group II, corresponding to outside diameters of 24.5 millimeters and 23.75 millimeters, respectively. The user would select the appropriate ring insert 140, which best fits within the required finger receiving opening 118, 124. Hole designated C/Cl corresponds to two insert rings 140 both having an inside diameter of 14.75 millimeters but different outside diameters, i.e., 24.5 and 23.75 millimeters.

The ring inserts 140 have been described as being singularly inserted into one of the finger receiving openings 118, 124. However, it is contemplated that a pair of ring inserts 140 may be nested together, as may be required, to accommodate the size of a particular finger receiving opening 118, 124. For example, if a person's finger measures 12.25 millimeters pursuant to template 148, the correspondence ring insert 140 may be selected from Group IV having an outside diameter of 20.25 millimeters. If this outside diameter is too small for the finger receiving opening 118, the ring insert 140 may be nested within the ring insert from group I having an inside diameter of 20 millimeters and an outside diameter of 24.5 millimeters. This combination provides a relatively small inside diameter and a relatively large outside diameter providing greater versatility to the ring inserts.

By way of further illustration only, and with reference to FIG. 5, smaller ring inserts 140 may be inserted into larger ring inserts such as by the following examples: ring insert A into ring inserts H or I: ring insert D into ring inserts F, G, or H: ring insert E into ring inserts F, G, or H: ring inserts F into ring insert I, etc.

To facilitate the selection of the appropriate ring insert 140, the holes 152 and ring inserts may be correspondingly coded such as by the use of color, letters, numbers, symbols, and combinations thereof. In accordance with one embodiment, each of the holes 152 on the template 148 are designated by the appropriate inside diameter and a letter that may be printed in a predetermined color. The ring inserts 140 may be similarly formed from polymer material that has the same color as the holes 152 of the same inside diameter. It is also contemplated that the ring inserts 140 may be stamped with a corresponding letter or inside diameter measurement. Accordingly, the holes 152 may be coded to a corresponding one of the ring inserts 140 using a variety of techniques.

Referring to FIG. 6, there is shown a template 154 in accordance with another embodiment of the present invention. The template 154 is in the nature of a graphic illustration 156 of a person's hand, and optionally, a separate graphic illustration 158 of a person's thumb. The graphic illustrations 156, 158 may be printed on a document supplied to the scissor's user along with the ring insert kit. It is also contemplated that the template 154 may be included in a software package or displayed on a computer screen at the point of purchase of the scissors. In this regard, the user would place his hand, as to be described more fully hereinafter, on the illustration 156 as it appears on a computer screen.

As noted, the user will place his hand overlying the hand illustration 156 with the edge of one's ring finger aligned with reference line 160. The user will press his ring finger lightly noting the area between the first and second knuckles generally identified by the two spaced apart knuckle reference lines 162, 164. The user will select the appropriate color/letter that matches the ring finger width associated with one of the ring finger reference lines 166. In this regard, each of the ring finger reference lines 166 may be of a different color, designated by a different letter, number, symbol, or combinations thereof. Based upon the designated ring finger reference line 166, the user can select the appropriate ring insert 140 from the ring insert kit.

In a like manner, the user places his thumb on the thumb illustration 158 aligned with the reference line 168. The user notes the area between the mid-thumb nail and bottom of the cuticle designated generally between thumb reference lines 170, 172. The thumb width is designated by selecting one of the thumb reference lines 174, which may also be coded to one of the ring inserts 140 in the manner as described with respect to the ring finger reference lines 166. Although the thumb illustration 158 has been shown separate from the hand illustration 156, it is contemplated that the thumb illustration may be included as part of the hand illustration. Having selected the appropriate ring inserts 140 for the user's ring finger and thumb, the ring inserts are inserted into the finger receiving openings 118, 124 of the scissors 100.

Although the present invention has been described with particular applicability to a pair of scissors 100, it is to be understood that any hand implement that is manipulated by one's fingers in a manner similar to a pair of scissors via finger receiving openings have applicability to the ring inserts and templates of the present invention.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A handle comprising a handle extension providing a first finger receiving opening, said handle extension including a first projection and a second projection projecting outwardly therefrom, said first and second projections spaced apart to provide therebetween a second finger receiving opening adapted to receive the middle finger of a person, said second finger receiving opening sized to prevent sliding movement of the person's middle finger over said handle extension.

2. The handle of claim 1, wherein said first and second finger receiving openings are separated by a portion of said handle extension forming said first finger receiving opening.

3. The handle of claim 1, wherein said first finger receiving opening is adapted to receive the ring finger of a person.

4. The handle of claim 1, wherein said first projection is directed away from said second projection.

5. The handle of claim 1, wherein said first projection has a triangular shape.

6. The handle of claim 1, wherein said second projection has a triangular shape.

7. The handle of claim 1, wherein said first and second projections are separated by an arcuate shaped portion of said handle extension.

8. The handle of claim 1, wherein said handle extension includes a closed ring forming said first finger receiving opening.

9. The handle of claim 1, wherein said second finger receiving opening has an arcuate shape.

10. The handle of claim 1, wherein said first and second projections are integrally formed with said handle extension.

11. A handle comprising a handle extension having spaced apart end portions, said handle extension providing a first finger receiving opening between said end portions, said handle extension including an arcuate shaped member forming said first finger receiving opening having a first segment directed towards one end portion of said handle extension and a second segment directed towards the other end portion of said handle extension, and a first projection projecting outwardly from said first segment providing a stop to prevent sliding movement of a person's finger onto said second segment of said handle extension, and a second projection spaced from said first projection providing a second finger receiving opening, wherein said first projection comprises a peak with two sloping surfaces, said peak projecting in a direction from said first segment away from said second segment.

12. The handle of claim 11, wherein said arcuate shaped member includes a crest between said first and second segments.

13. The handle of claim 12, wherein said first projection is arranged adjacent said crest.

14. The scissors of claim 11, wherein said first projection has a triangular shape.

15. The handle of claim 11, wherein said arcuate shaped member forms a portion of a circular member.

16. A handle comprising a handle extension including a first projection projecting outwardly therefrom, said first projection including a first peak bound by a first surface on one side of said first peak and a second surface on the other side of said first peak, said handle extension including a second projection projecting outwardly therefrom, said second projection having a second peak bound on at least one side by a third surface, said first and second peaks and said first and third surfaces providing a first finger receiving opening adapted to receive the middle finger of a person, said second surface of said first projection having a tangent line adjacent said first peak extending in a direction divergent with said first projection, whereby said first finger receiving opening is sized to prevent sliding movement of the person's middle finger over said first peak.

17. The handle of claim 16, wherein said first and second projections are separated by an arcuate shaped portion.

18. The handle of claim 16, wherein said first projection has a triangular shape.

19. The handle of claim 16, wherein said second projection has a triangular shape.

20. The handle of claim 16, wherein said handle extension includes a closed ring.
